(19) United States
(12) Patent Application Publication
(10) Pub. No.: US 2017/0180769 A1
(43) Pub. Date: Jun. 22, 2017

(54) SIMULTANEOUS EXPERIENCE OF MEDIA

(71) Applicant: Cevat Yerli, Frankfurt am Main (DE)

(72) Inventor: Cevat Yerli, Frankfurt am Main (DE)

(21) Appl. No.: 14/975,454

(22) Filed: Dec. 18, 2015

(51) Int. Cl. H04N 21/242; H04N 21/43

(52) U.S. Cl. CPC H04N 21/242; H04N 21/4305

(57) ABSTRACT

A method for simultaneous experience of media is disclosed. The method comprises the acts of connecting a media host to a plurality of clients, each client configured to render media, receiving a plurality of messages from two or more clients of a subset of the plurality of clients, each message indicating that a respective client of the subset is prepared to render media content, notifying each client of the subset of an expected starting time for rendering the media content, providing at least a part of the media content from the media host to each client of the subset, and initiating, at the expected starting time, a countdown, the countdown being signaled to each client of the subset, wherein each client of the subset is configured to initiate rendering of the media content at the end of the countdown. Furthermore, a media system and a respective client device are described.

### TECHNICAL FIELD

The present disclosure relates to a method for simultaneous experience of media, a media system, and a respective client device. In particular, the present disclosure may relate to simultaneous experience of media on a plurality of client devices that may be triggered by a countdown.

### BACKGROUND

Current electronic devices enable an experience of various media content, such as audio or video content. Such content may, for example, be broadcasted to a plurality of subscribers or provided to an audience in a theater or cinema or the like. A shared experience of media may be limited in that the media content cannot be adapted for each viewer individually, such as in the case of a cinema or theater, where the same content is provided to the whole audience. On the other hand, if several output devices are used for individual viewers or groups of viewers, such as several TV sets, the media content will typically be rendered on the individual output devices at slightly different points in time, thereby disturbing a simultaneous experience. For example, if viewers of a live broadcast of a sports event receive the broadcast via a cable network and a satellite connection, respectively, the live broadcast will be provided at the individual output devices with a perceivable offset, for example with regard to events in the live broadcasting, which may disturb a simultaneous experience.

Hence, one object of the present disclosure is to enable a simultaneous experience of media on a plurality of output devices.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The object is achieved by a method for simultaneous experience of media, a media system, and a client device according to the present disclosure.

A first aspect of the present disclosure provides a method for simultaneous experience of media that comprises the act of connecting a media host to a plurality of clients, each client configured to render media, receiving a plurality of messages from two or more clients of a subset of the plurality of clients, each message indicating that the respective client of the subset is prepared to render media content, notifying each client of the subset of an expected starting time for rendering the media content, providing at least a part of a media content from the media host to each client of the subset, and initiating, at the expected starting time, a countdown, the countdown being signaled to each client of the subset, wherein each client of the subset is configured to initiate rendering of the media content at the end of the countdown.

The method enables a plurality of clients to register or connect to a media host, wherein individual clients may indicate, via respective messages, that they are prepared to render media content. This may enable the media host to communicate with a plurality of clients that are potentially available for providing of media content. However, the media host may also assign resources for distribution of the media content to clients that have registered via said messages. This may enable a better adaptation of the media host to a particular infrastructure of clients.

In order to enable a simultaneous experience of the media content on each of the plurality of clients of the subset of registered clients, the media host may set an expected starting time for rendering and may communicate the expected starting time to the clients. In turn, the clients may prepare for rendering, for example, by performing respective initialization and/or configuration steps. Preferably, the media host may inform the clients of the subset of registered clients about the media content and respective rendering parameters. This may enable individual clients to initialize and/or configure respective output means, for example, output means for individual modalities of the viewer. Each client may confirm to the media host that its initialization and/or configuration has been completed and that the client is ready to start rendering of the notified media content at the expected starting time. However, if a client cannot complete respective initialization or configuration, the client may request that the starting time is postponed to a later point in time. The media host may then accept or reject the request and may inform the other clients of a postponed starting time accordingly. This ensures that all clients are set up and ready to render the media content at the expected starting time.

After notification of each client of the expected starting time or during said notification, the media host may start providing at least a part of the media content to each client of the subset of registered clients. Preferably, the media content is streamed from the media host to the client. The clients may include a buffer or another temporal storage means to store the provided part of the media content. Furthermore, the clients may preprocess the provided media content, analyze the provided media content with regard to rendering requirements, and/or may check the provided media content to comply with rendering capabilities of each individual client. The clients may thereafter inform the media host that preprocessing, analysis and/or checking of the provided media content has been completed. However, it is to be understood that the steps are optional. This enables each individual host to prepare the provided part of the media content for immediate rendering at the expected starting time.

Due to different timers, clocks or other time indication means used on the clients, for example slightly deviating clocks, the notified expected starting time may lead to different starting times across the clients, with respect to each other. Therefore, the clients will not start rendering at the expected starting time but wait for a countdown which is initiated and signaled to each client of the subset of registered clients. The countdown may be defined by parameters, including a number of steps and respective time intervals between the steps. The time intervals may have the same length. The parameters may be initially transmitted to the clients. Each step may be signaled to each client of the subset using a very short message or signal, which may even include a single bit, a single impulse or a single peak of a signal on a dedicated link. Based on the total number of steps, each client may reproduce the countdown and configure for initiation of the rendering at the end of the countdown. For example, each client may take into account slight variations of the time intervals between subsequent steps in order to estimate and adjust the (local) end of the countdown. This processing enables a determination of an exact starting time which is substantially the same across the plurality of clients. In particular, the method according to the present disclosure reduces the variations of the starting time across the plurality of clients below a noticeable threshold in the range of milliseconds, thereby enabling a synchronized provision and simultaneous experience of the provided media content.

After initiation of the rendering on the clients, the media host may continue providing further parts of the media content, for example, by continuing streaming the media content to the individual clients.

In an embodiment, the countdown determines an expiry time and each client is configured to initiate said rendering of the media content at the expiry time of the countdown. For example, the parameters of the countdown may define a total number of steps at respective time intervals between the steps. A sum of the time interval may define the expiry time with regard to the first step of the countdown. For example, a countdown may define ten steps with time intervals of a same length t, which may lead to an expiry time of 10×t. However, it is to be understood that more or fewer steps and shorter or longer time intervals with a varying length can be used, which can, for example, be defined as a vector T=(t₀, t₁, . . . , tₙ) for n+1 steps. For example, the time intervals may be decreasing with the number of steps, such that tᵢ≦tᵢ₊₁. This may allow for a fine granular control of initiation of rendering of the media on the clients.

In yet another embodiment, the method further comprises estimating a time delay for each client of the subset, wherein the time delay is indicative of a duration of communication between the media host and the respective client. Preferably, said estimating may comprise exchanging synchronization messages with each client to estimate the time delay. The media host may send a synchronization message to a particular client and may wait for a return message in order to determine a round trip time (RTT) for communication with the individual client. A half of the estimated round trip time may be used as an estimate for the time delay in communicating with the client. The estimation may be repeated in order to adjust the time delay based on current conditions of a communication link or network.

In an embodiment, on a respective client, the rendering is initiated based on the estimated time delay and the expiry time of the countdown. The media host or any other entity may estimate the time delay and may communicate the estimated time delay to the client prior to initiating the countdown. After initiation of the countdown, the client may process the parameters of the countdown to adjust the expiry time of the countdown by the time delay and may synchronize the countdown according to the signaled steps of the countdown. This further contributes to a synchronization of rendering of the media on the individual clients across the plurality of clients.

According to yet another embodiment, the media content is provided or streamed to each client of the subset using a network and the countdown is signaled using a link. For example, the network may be a standard communication, an IP based network, or broadcasting network, which can be further optimized for providing or streaming the media content. The network may allow for a certain latency and variation in transmission speed and bandwidth. Accordingly, the media content may be adapted to the available resources. For example, the quality of the media content may be reduced in order to enable a timely delivery of the media content. Furthermore, the plurality of clients may be connected using a dedicated link, which can be used to signal the countdown to the clients. This may enable very short transmission time for the individual countdown steps and a very small message size that may even amount to a single bit or an impulse of a signal on the dedicated link.

In yet another embodiment, the media content includes one or more sections, the method further comprising notifying each client of the subset of a next section of the one or more sections to be rendered at the expected starting time, wherein each client is configured to initiate rendering of the next section of the media content at the end of the countdown. For example, the sections may correspond to chapters or other portions or fractions of the media content, which can be played in a linear order. The sections may also define more fine granular portions or fractions of the media content. Their boundaries may correspond to a plurality of synchronization points during the media content, which may enable additional users to join in the simultaneous presentation of the content. Furthermore, at certain points, different sections of the media content may be provided to different clients and the media content may again be synchronized at boundaries of other sections in order to again synchronize the media on all clients. Boundaries between sections of the media content may be used to interrupt provision of the media content and provide other media content in a break, such as advertisements and the like. Again, initiation of a next section of the media content may be synchronized using embodiments of the present disclosure to continue the provision of other sections of the media content. This enables breaks in the rendering of the media content, a subsequent provision of media content targeted to individual users of the clients, and subsequent resuming of the media content in a synchronized fashion on all clients, which again allows for a simultaneous experience of the media content across the clients.

In yet another embodiment, the method further comprises receiving a message from a further client of the plurality of clients, the message indicating that the further client is prepared to render media content, and adding the further client to the subset. The further client may not have been initially registered in the subset of clients. For example, a user may decide to join the simultaneous experience at a later point in time by providing respective user input at the further client. Responsive to the user input, the further client may transmit the message via the established connection to the media host in order to register for a next countdown. The further client may inform the user about the next point in time, such as by indicating a next estimated expected starting time to the user. For example, the next expected starting time may be bound to a further section or synchronization point of the media content. Preferably, the further client is notified about an expected starting time for rendering the media content.

In one embodiment, the method further comprises determining whether the countdown has already been initiated prior to receiving the message from the further client, and initiating a further countdown for the further client with a shortened expiry time, wherein the shortened expiry time corresponds to the expiry time of the countdown. This allows for registration of further clients at short notice even after the countdown has been initiated. However, in order to provide a simultaneous experience of the media content at all clients, the method may further comprise an estimation whether the shortened expiry time is sufficient to synchronize the countdown on the further client. If the shortened expiry time falls below a threshold, the further countdown could be interrupted and the further client could be scheduled for a next expected starting time, such as at another section of the media content or at a next synchronization point of the media content.

In a further embodiment, said rendering includes providing at least one of video output, an audio output, and a haptic output. Preferably, the media content is immersive media content. Hence, the immersive media content may provide information for rendering the media content in respective modalities, including the visual, auditory and haptic modality. The media content may be rendered in an immersive way, for example, by applying stereoscopic rendering, binaural acoustics and realistic force feedback stimuli. Accordingly, the clients may be virtual reality clients.

In an embodiment, the plurality of clients are arranged in a presentation room and the media content is rendered on the client devices of the subset simultaneously in the presentation room. Even though each user may operate an individual client, which may provide a personalized experience of the media content to the user, the users will perceive the experience of the media content as a simultaneous experience since the individual users may still perceive the other users' reactions on the media content, for example by hearing their reactions to a particular part or event of the simultaneously provided media content. Hence, the simultaneous experience of the synchronized media content in a presentation room, such as a theater or a cinema, provides for a highly realistic and shared experience for the entire audience, which may be, however, individualized for each individual viewer. Hence, visitors of cinemas or similar venues may experience and enjoy media content, such as a simultaneous virtual reality experience via individual virtual reality headsets, wherein the experienced media content is perfectly time synchronized with the other visitors.

According to another aspect of the present disclosure, a media system comprises at least one media host communicatively coupled to a plurality of client devices, each client configured to render media, a timer component, and a processing component, wherein the processing component is configured to connect the at least one media host to the plurality of clients, receive a plurality of messages from two or more clients of a subset of the plurality of clients, each message indicating that the respective client of the subset is prepared to render media content, notify each client of the subset of an expected starting time for rendering the media content, provide at least a part of the media content from the at least one media host to each client of the subset, and initiate by the timer component a countdown at the expected starting time, the countdown being signaled to each client of the subset, wherein each client of the subset is configured to initiate rendering of the media content at the end of the countdown.

In one embodiment, the processing component is further configured to estimate a time delay for each client of the subset, wherein the time delay is indicative of a duration of communication between the at least one media host and the respective client.

In a further embodiment, to estimate the time delay, the processing component is further configured to exchange synchronization messages with each client.

According to one embodiment, the at least one media host is connected to the clients of the subset using a network to provide or stream the media content, wherein the timer component is connected to the clients of the subset using a link to signal the countdown.

In another embodiment, the media content includes one or more sections, wherein the processing component is further configured to notify each client of the subset of a next section of the one or more sections to be initiated at said expected starting time, wherein each client is configured to initiate rendering of the next section of the media content at the end of the countdown.

In one embodiment, the processing component is further configured to receive a message from a further client of the plurality of clients, the message indicating that the further client is prepared to render media content, and add the further client to the subset.

According to another embodiment, the processing component is further configured to notify the further client of an expected starting time for rendering the media.

In yet another embodiment, the processing component is further configured to determine whether the countdown has already been initiated prior to receiving the message from the further client, and initiate by the timer component a further countdown for the further client with a shortened expiry time, wherein the shortened expiry time corresponds to the expiry time of the countdown.

According to one embodiment, the plurality of clients are arranged in a presentation room and the media content is rendered on the client devices of the subset simultaneously in the presentation room.

According to yet another embodiment, the media content is immersive media content.

According to a further aspect, a client device comprises a rendering component configured to render media, at least one buffer, and a processor being configured to establish a connection to a media host, responsive to a determination that the client device is prepared to render media content, send a message to the media host indicating that the client device is prepared to render the media content, receive from the media host a notification of an expected starting time for rendering the media content, receive from the media host at least a part of the media content, buffer the received media content in the at least one buffer, receive a countdown from the media host, and initiate rendering of the buffered media content at the end of the countdown. The media content may be provided as a media stream or as parts of the media content which may be buffered in the buffer and rendered on the client device.

In one embodiment, the processor is further configured to initiate said rendering of the media content at an expiry time of the countdown. For example, the client device may further comprise a clock or a time component, which may indicate a local time of the client device. The countdown may specify a time duration. Hence, after receipt of a signal corresponding to the first step of the countdown, which may be a single signal or a short message, the client device may estimate, using the clock or timing component, the expiry time of the countdown that may be used to trigger rendering of the buffered media content. The client device may also adjust the expiry time based on any subsequent signal corresponding to a next step of the countdown based on parameters of the countdown, including the number of steps and the time intervals between the individual steps.

In another embodiment, the processor is further configured to determine a time delay and initiate said rendering of the media content based on the time delay and the expiry time of the countdown. For example, the processor may communicate with a media system providing the media content and may listen to a synchronization message sent by the media system in order to directly return another synchronization message to the media system, which may thereafter determine a round trip time to determine the time delay. The media system may communicate the time delay to the client. However, it is to be understood that each client may individually determine its time delay by initiating synchronization message on the client which may be, in turn, returned by the media system in order to determine the time delay locally on the client device.

According to a further embodiment, the client device further comprises at least one output device for rendering the media content. Preferably, the at least one output device includes at least one of video output assembly, an audio output assembly, and/or a haptic output assembly.

In an embodiment, the client device is a virtual reality client configured to render immersive media content. For example, the client device may render a stereoscopic representation of a three-dimensional representation of a scene, may provide binaural audio output and may further use haptic output devices to provide haptic sensation to a user. The client device may further comprise tracking means to determine position and orientation of the client device, which can further be used to adjust rendering of the immersive media content.

According to yet another aspect, a computer-readable medium is provided, which comprises instructions that, when installed and/or executed on a computing device, cause the computing device to perform a method according to one or more embodiments of the present disclosure. For example, the computing device may be a media system, a media host or a client device according to one embodiment of the present disclosure, in any combination.

Devices according to embodiments of the present disclosure, such as the media system, the client device and the media host may be implemented as one or more dedicated computing devices with at least one processor and at least one memory. Furthermore, the media system may communicate with the individual client devices via a dedicated network to implement embodiments of the present disclosure.

### BRIEF DESCRIPTION OF THE DRAWINGS

The specific features, aspects and advantages of the present disclosure will be better understood with regard to the following description and accompanying drawings where:

FIG. 1 shows a system infrastructure for implementing one embodiment of the present disclosure; and

FIG. 2 shows a flow chart of a method according to one embodiment of the present disclosure.

### DETAILED DESCRIPTION

In the following description, reference is made to drawings which show by way of illustration various embodiments. Also, various embodiments will be described below by referring to several examples. It is to be understood that the embodiments may include changes in design and structure without departing from the scope of the claimed subject matter.

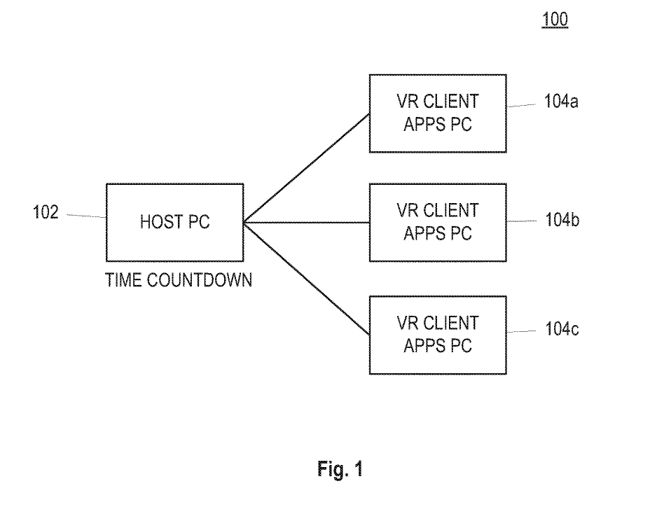

FIG. 1 shows a schematic illustration of a system infrastructure for implementing one embodiment of the present disclosure. The system 100 may include a host 102, which may be coupled to a plurality of clients 104a, 104b, 104c, for example, via a network. The clients 104a, 104b, 104c may be virtual reality clients. Virtual reality clients may include a computer and connected virtual reality output devices, for example head-mounted displays, computerized glasses and the like. Virtual reality clients may also include acoustic output devices, such as earphones, which may be configured to provide respective output creating an immersive experience of the rendered sound. However, it is to be understood that virtual reality clients need not be restricted to audio/video output only and may render the media content according to further modalities, such as by providing haptic, gustatory and/or olfactory output in order to create an immersive experience of the rendered media content.

The host 102 may include a media server for providing immersive media content to the clients 104a, 104b, 104c, as well as further processing components that may communicate to the clients 104a, 104b, 104c an expected starting time for rendering the media content in order to enable a simultaneous experience of the rendered media content on the individual clients 104a, 104b, 104c. The clients 104a, 104b, 104c may configure themselves for rendering of the media content at the expected starting time and may receive at least parts of the media content from the host 102, which can be buffered at the clients 104a, 104b, 104c.

After a predetermined time delay or after the host 102 has received confirmation messages from the clients 104a, 104b, 104c, the host 102 may initiate a countdown. This may include communicating countdown parameters to the clients 104a, 104b, 104c, which may include a number of steps of the countdown and respective time intervals between the steps of the countdown, and subsequent signaling of each step from the host 102 to the clients 104a, 104b, 104c. Each client 104a, 104b, 104c may receive the signaled steps and use this information to calculate an expiry time of the countdown and/or further adjust the expiry time as the countdown progresses.

The synchronization using the countdown leads to a perfectly time-synchronized initiation of rendering of the media content on the plurality of clients 104a, 104b, 104c. By initiating the countdown, the host 102 triggers a simultaneous real-time experience in each individual client 104a, 104b, 104c.

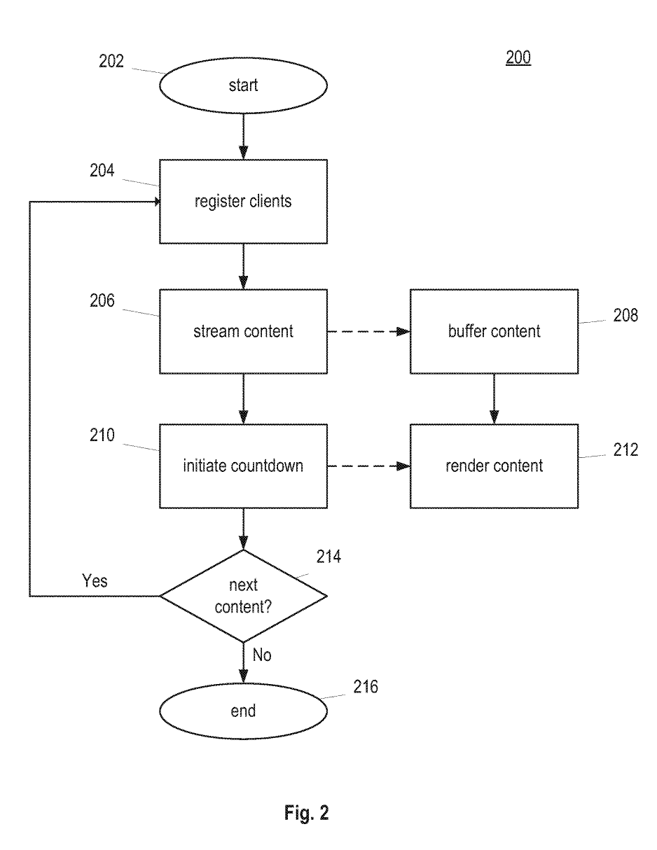

FIG. 2 shows a flow chart of a method according to one embodiment of the present disclosure.

The method 200 may start in item 202. For example, a media system, such as the host 102 of FIG. 1 can be initiated.

In item 204, a plurality of clients may be registered with the media system. The clients may correspond to client devices 104a, 104b, 104c as shown in FIG. 1. At least some of the clients may register with the media system by sending respective messages and indicating that the client is prepared to render media content.

In item 206, the system may start streaming media content and may further notify each registered client of an expected starting time for rendering the media content.

The clients may receive the media content and may buffer the received content in item 208. Each client may signal to the media system that the received media content has been buffered 208 and that the client is ready for rendering the media content at the expected starting time.

The media system may optionally collect confirmations from the clients and may initiate a countdown 210 at the expected starting time. The countdown may be defined by countdown parameters, including at least a number of steps and respective time intervals between the steps, and/or a (global) expiry time of the countdown, which may correspond to the sum of the time intervals between the steps of the countdown. For example, the countdown may specify an expiry time as “00:00:10,” which may indicate 10 countdown steps of an equal duration of one second. In turn, the clients may receive a signaling of the countdown, such as signals or messages indicating individual steps of the countdown, and may use the signals or messages to adjust a local expiry time of the countdown. At the expiry time of the countdown, each client may render the content in item 212. This provides for a simultaneous and synchronized experience of the media content across a plurality of clients.

The method 200 may proceed with item 214, where it may be determined whether next media content is to be provided. The next media content may be separate media content or may correspond to another section or portion of the media content. If further media content is to be provided, processing may continue with item 204. Optionally, processing may also continue with item 206 or 210. For example, the media system may continuously stream content to registered clients and may initiate respective countdowns at synchronization points in order to synchronize rendering of the media content on the individual clients.

If no further content is to be provided, the method may end in item 216.

While some embodiments have been described in detail it is to be understood that aspects of the disclosure can take many forms. In particular, the claimed subject matter may be practiced or implemented differently from the examples described and the described features and characteristics may be practiced or implemented in any combination. The embodiments shown herein are intended to illustrate rather than to limit the invention as defined by the claims.

The embodiments of the invention in which an exclusive property or privilege is claimed are defined as follows:

1. A method for simultaneous experience of media, comprising:
connecting a media host to a plurality of clients, each client configured to render media;
receiving a plurality of messages from two or more clients of a subset of the plurality of clients, each message indicating that a respective client of the subset is prepared to render media content;
notifying each client of the subset of an expected starting time for rendering the media content;
providing at least a part of the media content from the media host to each client of the subset; and
initiating, at the expected starting time, a countdown, the countdown being signaled to each client of the subset, wherein each client of the subset is configured to initiate rendering of the media content at the end of the countdown.

2. The method according to claim 1, wherein the countdown determines an expiry time and each client is configured to initiate said rendering of the media content at the expiry time of the countdown.

3. The method according to claim 1, further comprising estimating a time delay for each client of the subset, wherein the time delay is indicative of a duration of communication between the media host and the respective client.

4. The method according to claim 3, wherein said estimating further comprises exchanging synchronization messages with each client to estimate the time delay, wherein, on a respective client, the rendering is initiated based on the estimated time delay and an expiry time of the countdown.

5. The method according to claim 1, wherein the media content is provided to each client of the subset using a network and wherein the countdown is signaled using a link.

6. The method according to claim 1, wherein the media content includes one or more sections, the method further comprising notifying each client of the subset of a next section of the one or more sections to be rendered at said expected starting time, wherein each client is configured to initiate rendering of the next section of the media content at the end of the countdown.

7. The method according to claim 1, further comprising receiving a message from a further client of the plurality of clients, the message indicating that the further client is prepared to render media content, and adding the further client to the subset.

8. The method according to claim 7, further comprising:
determining whether the countdown has already been initiated prior to receiving the message from the further client; and
initiating a further countdown for the further client with a shortened expiry time, wherein the shortened expiry time corresponds to the expiry time of the countdown.

9. The method according to claim 1, wherein said rendering includes providing at least one of a video output, audio output, and haptic output.

10. The method according to claim 1, wherein the media content is immersive media content and the clients are virtual reality clients.

11. A media system comprising:
at least one media host communicatively coupled to a plurality of client devices, each client configured to render media;
a timer component; and
a processing component, the processing component being configured to:
connect the at least one media host to the plurality of clients;
receive a plurality of messages from two or more clients of a subset of the plurality of clients, each message indicating that a respective client of the subset is prepared to render media content;
notify each client of the subset of an expected starting time for rendering the media content;
provide at least a part of the media content from the at least one media host to each client of the subset; and
initiate by the timer component a countdown at the expected starting time, the countdown being signaled to each client of the subset, wherein each client of the subset is configured to initiate rendering of the media content at the end of the countdown.

12. The system according to claim 11, wherein the processing component is further configured to estimate a time delay for each client of the subset, wherein the time delay is indicative of a duration of communication between the at least one media host and the respective client.

13. The system according to claim 11, wherein the at least one media host is connected to the clients of the subset using a network to provide the media content and wherein the timer component is connected to the clients of the subset using a link to signal the countdown.

14. The system according to claim 11, wherein the plurality of clients are arranged in a presentation room and the media content is rendered on the client devices of the subset simultaneously in the presentation room.

15. The system according to claim 11, wherein the media content is immersive media content.

16. A client device comprising:
a rendering component configured to render media;
at least one buffer; and
a processor being configured to:
establish a connection to a media host;
responsive to a determination that the client device is prepared to render media content, send a message to the media host indicating that the client device is prepared to render the media content;
receive from the media host a notification of an expected starting time for rendering the media content;
receive from the media host at least a part of the media content;
buffer the received media content in the at least one buffer;
receive a countdown from the media host; and
initiate rendering of the buffered media content at the end of the countdown.

17. The client device according to claim 16, wherein the processor is further configured to initiate said rendering of the media content at an expiry time of the countdown.

18. The client device according to claim 16, wherein the processor is further configured to determine a time delay and initiate said rendering of the media content based on the time delay and an expiry time of the countdown.

19. The client device according to claim 16, further comprising at least one output device for rendering the media content, wherein the at least one output device includes at least one of a video output assembly, an audio output assembly, and a haptic output assembly.

20. The client device according to claim 16, wherein the client device is a virtual reality client configured to render immersive media content.
